(19) United States
(12) Patent Application Publication
(10) Pub. No.: US 2021/0032902 A1
(43) Pub. Date: Feb. 4, 2021

(54) LOCK WITH EXTERIOR ACTIVATION SENSOR FOR COMMUNITY LOCKERS

(71) Applicant: OJMAR, S.A., Shezhen, Guangdong (CN)

(72) Inventor: Ricardo SENDIN MARTIN, Elgoibar (ES)

(73) Assignee: OjMar, S.A., Shezhen, Guangdong (CN)

(21) Appl. No.: 16/645,134

(22) PCT Filed: Jul. 7, 2018
(86) PCT No.: PCT/ES2018/070512

§ 371 Date: Mar. 6, 2020

(30) Foreign Application Priority Data
Sep. 12, 2017 (ES) P201731109

(51) Int. Cl. E05B 47/00; G07C 9/29; E05B 65/02; G07C 9/00

(52) U.S. Cl. CPC E05B 47/0001; G07C 9/29; E05B 65/025; E05Y 2400/612; E05B 2047/0073; E05B 2047/0087; E05B 2047/005; E05Y 2400/856; E05Y 2900/20; G07C 2009/00642

(57) ABSTRACT

A lock (1) with an exterior activation sensor (2) includes an interior electromechanical mechanism (3) with a corresponding power supply unit (4) and an exterior activation sensor (2) situated on the external part of the locker, and which is used in community lockers or similar, wherein the exterior activation sensor (2) contains at least two respective internal electrical contacts (5) which, by means of a conductive circuit (6), reach the inside of the lock and connect in parallel to the interior poles of the circuit (4a) of the power supply unit (4).

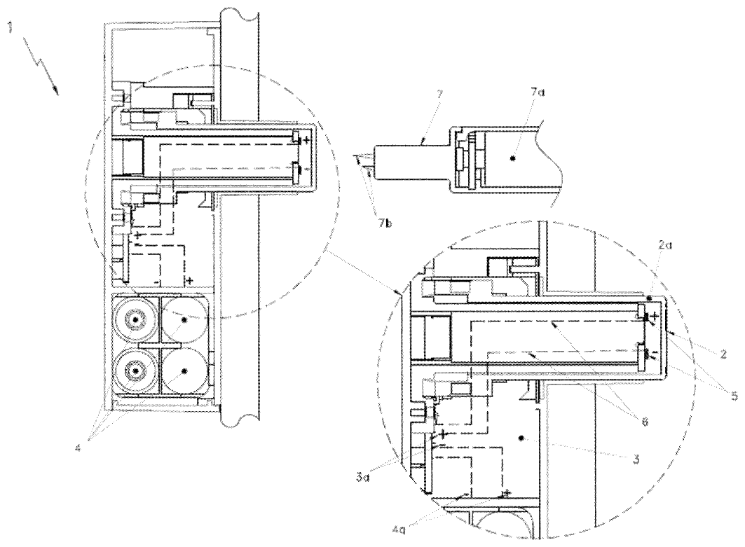

### CROSS REFERENCE TO RELATED APPLICATIONS

This application claims priority of Application No. P201731109 filed in Spanish on Sep. 12, 2017 under 35 U.S.C. § 119, the entire contents of all of which are hereby incorporated by reference.

### FIELD OF THE INVENTION

This invention relates to a lock with an activation sensor that is used for the opening and closing of community lockers by means of a proximity format such as a card, wristband or electronic key.

### STATE OF THE ART

At present and as a reference to the state of the art, it is usual and known to use different types of electronic locks for the opening and closing of community lockers.

Also usual and known is the use of locks that have an external activation sensor and are generally composed of an internal electromechanical mechanism with a corresponding power unit and are activated by the proximity of a card, wristband, electronic key or by inserting a security code through an electronic keyboard. In addition, it is possible to customise the lock so that it opens automatically after a specific period of time or time. They also have a colored LED to indicate the status of the lock (free or busy). These types of lock also incorporate a system that detects the low battery level of the power unit.

One of the problems caused by these types of locks is that there may be sudden voltage drops in the power supply unit during its useful life due to exceptional situations, such as the appearance of internal porosity, and which are not foreseeable due to the battery level detection system of the power supply unit, causing the automatic locking of the lock and consequently making it impossible to open. Because of this problem, technical support has not foreseen how it will deal with a lock that has been rendered useless by battery failure of the power unit, its opening still not being possible even with a master key. Therefore, this problem involves mechanically forcing the lock, whereby usually the door of the locker in which the lock is housed is damaged, having to be replaced it with a completely new one. Furthermore, as the door must be substituted with another of the same color, the color of the rest of the doors of the space or enclosure will not coincide due to the type of environment (wet or dry) and the passage of time. This means having to change not only a single door but all the doors of the lockers of the entire installation, which generates considerable economic and maintenance costs.

### EXPLANATION OF THE INVENTION AND ADVANTAGES

Faced with this state of affairs, the present invention refers to a lock with an external activation sensor, of which it possesses an internal electromechanical mechanism with a corresponding power unit and an external activation sensor located on the outside of the locker, and is employed in community lockers or similar, where the external activation sensor houses therein at least two respective internal electrical contacts, which, through a driver circuit, reach the interior of the lock and connect in parallel with the inner poles of the circuit of the power unit.

With this configuration, the simple opening of the lock is achieved in case of emergency due to a sharp drop in voltage of the power supply unit without having to completely break the lock and replace it with a completely new one, as well of not having to replace the door of said locker and, therefore, all doors of the space or enclosure, avoiding considerable economic and maintenance costs. In addition, the application of this invention is possible not only to an external mechanical activation sensor, but also to an electronic one (capacitive, LPCD . . . ).

Another feature of the invention is that it is provided that the internal electrical contacts are located under the outer housing of the outer activation sensor. As well as that most of the lock is placed inside the locker, which makes access to the power contacts somewhat difficult to prevent opening by a person who is not part of the maintenance staff and thus avoid theft thereof.

With this arrangement, easy and simple access to the internal electrical contacts of authorised personnel is possible, it being possible to open the lock in case of emergency and, consequently, easily repair of lock, without compromising the safety thereof.

Another feature of the invention is that it is provided that the outer housing of the external activation sensor possesses exterior identification indicators where it is indicated that the internal electrical contacts are to be found.

With this configuration, the location of the internal electrical contacts is facilitated by making the work of the maintenance staff easier and enabling the quick opening of the lock in case of emergency blocking.

Another feature of the invention is that it is provided that the outer housing of the exterior activation sensor is made of flexible material that can be traversed, allowing the internal electrical contacts to easily be reached.

With this configuration, access to internal electrical contacts is gained easily, quickly and efficiently with simple lifting or removing of the outer housing of the external activation sensor.

Finally, another feature of the invention is that an external emergency opening tool is provided that incorporates an additional power supply unit and respective connection contacts corresponding with the internal electrical contacts. With this configuration, a quick, simple and direct opening of the lock is achieved in the event of emergency.

### DRAWINGS AND REFERENCES

In order to better understand the nature of the invention, an industrial embodiment is shown in the accompanying drawings that is merely for illustrative and not restrictive purposes.

The FIGURE shows a sectional view of the profile of the lock (1) housed in the door of the locker. The external emergency opening tool (7) is also observed, with its supplementary power supply unit (7a) and the connection contacts (7b).

In an enlarged detail, the interior of the lock (1) is also shown and one may observe therein the internal electrical contacts (5) under the outer housing (2a) of the external activation sensor (2) connected by the driver circuit (6) parallel to the inner poles of the circuit (4a) of the power unit (4).

The following references are indicated in the FIGURE:
1.—Lock
2.—External activation sensor
2nd.—External housing of the external activation sensor (2)
3.—Internal electromechanical mechanism
3a.—Internal poles of the circuit of the internal electromechanical mechanism (3)
4.—Power unit
4a.—Internal poles of the power unit circuit (4)
5.—Internal electrical contacts
6.—Driver circuit
7.—External emergency opening tool
7a.—Supplementary power supply unit
7b.—Connection contacts

### Exhibition of a Preferred Embodiment

In relation to the drawings and references listed above, a preferred mode of execution of the object of the invention, referring to a lock (1), is illustrated in the attached drawings with the external activation sensor (2), of which it has an internal electromechanical mechanism (3) with a corresponding power unit (4) and an external activation sensor (2) located in the external part of the locker, and which are used in community lockers or similar, in which the external activation sensor (2) houses in its interior at least two respective internal electrical contacts (5) that, through a driver circuit (6), reach the interior of the lock (1) and connect in parallel with the inner poles of the circuit (4a) of the power supply unit (4).

In the enlarged detail of the FIGURE, it is observed that the internal electrical contacts (5) are located under the outer housing (2a) of the external activation sensor (2), thus enabling the simple opening of the lock (1) in the event of emergency and, therefore, easy repair thereof. It is also provided that the outer housing (2a) of the outer activation sensor (2) has external identifying indicators, where it indicates that the internal electrical contacts (5) are present. In this manner, the location of the internal electrical contacts is facilitated, making the work of the maintenance staff easier and enabling the quick opening of the lock (1) in the event of emergency blocking.

It is also provided that the outer housing (2a) of the external activation sensor (2) is made of flexible materials that can be traversed and easily reach the internal electrical contacts (5), thereby gaining access to the internal electrical contacts (5) in a simple, fast and effective manner by simply lifting or removing the outer housing (2a) of the external activation sensor (2).

In the enlarged detail, it is also shown that the inner electromagnetic mechanism (3) has inner poles of the circuit (3a) through which it receives energy from the power unit (4).

Through the emergency opening tool (7), with its supplementary power unit (7a) and the respective connection contacts (7b), one may observe how the internal electrical contacts (5) are easily accessed, and that, through a driver circuit (6), they reach the inside of the lock (1) and connect in parallel with the inner poles of the circuit (4a) of the power unit (4), thus allowing the rapid, simple and straightforward opening of the lock (1) in case of emergency locking.

Variations in materials, shape, size and arrangement of the component elements, described in a non-limiting manner, do not alter the essence of this invention, this being sufficient to proceed to its reproduction by an expert.

1. A lock (1) with an exterior activation sensor (2), which has an interior electromechanical mechanism (3) with a corresponding power supply unit (4) and an exterior activation sensor (2) situated on the external part of the locker, and which is used in community lockers or similar, wherein the exterior activation sensor (2) contains at least two respective internal electrical contacts (5) which, by means of a conductive circuit (6), reach the inside of the lock and connect in parallel to the interior poles of the circuit (4a) of the power supply unit (4).

2. The lock (1) with an external activation sensor (2), according to claim 1, wherein it is provided that the internal electrical contacts (5) are situated below the outer housing (2a) of the external activation sensor (2).

3. The lock (1) with an external activation sensor (2) according to claim 2, wherein it is provided that the external housing (2a) of the external activation sensor (2) has external identification indicators where it is indicated that the internal electrical contacts (5) are present.

4. The lock (1) with an external activation sensor (2) according to claim 2, wherein it is provided that the outer housing (2a) of the external activation sensor (2) is made of flexible material that allows it to be traversed and easily reach the internal electrical contacts (5).

5. The lock (1) with an external activation sensor (2) according to claim 1, wherein the existence of an external emergency opening tool (6) is foreseen, incorporating a supplementary power unit (6a) and respective connection contacts (6b) corresponding with the internal electrical contacts (5).
